(19) United States
(12) Patent Application Publication
(10) Pub. No.: US 2020/0162659 A1
(43) Pub. Date: May 21, 2020

(54) DATA CONVERSION AND PHOTOGRAPHING CONTROL METHOD AND SYSTEM, GIMBAL ASSEMBLY AND UNMANNED AERIAL VEHICLE SYSTEM

(71) Applicant: SZ DJI TECHNOLOGY CO., LTD., Shenzhen (CN)

(72) Inventors: Yuanjia CAI, Shenzhen (CN); Zhendong WANG, Shenzhen (CN); He ZHANG, Shenzhen (CN); He CUI, Shenzhen (CN)

(21) Appl. No.: 16/747,835

(22) Filed: Jan. 21, 2020

Related U.S. Application Data
(63) Continuation of application No. PCT/CN2017/095164, filed on Jul. 31, 2017.

(51) Int. Cl. H04N 5/232; H04N 5/225; G03B 17/56; H04W 4/18; B64C 39/02

(52) U.S. Cl. CPC H04N 5/23203; H04N 5/2252; G03B 17/561; B64C 2201/127; B64C 39/024; B64C 2201/123; H04W 4/18

(57) ABSTRACT

A data conversion method applied to a data conversion device, including: receiving camera control signals transmitted by a remote control device; converting a format of the camera control signals to a protocol format of a camera; and transmitting the converted camera control signals to the camera. The data conversion device is connected to a gimbal and the camera, and the gimbal is controlled by the remote control device.

### CROSS-REFERENCE TO RELATED APPLICATION

This application is a continuation of International Application No. PCT/CN2017/095164, filed Jul. 31, 2017, the entire content of which is incorporated herein by reference.

### TECHNICAL FIELD

The present disclosure relates to the technology field of photographing control, and in particular relates to a data conversion and photographing control method and system, a gimbal assembly, and an unmanned aerial vehicle system.

### BACKGROUND

With the development of photographing technology, users have increasing demand on images taken by cameras.

Often, in order to achieve stabilization of the camera, the camera may be fixed on a gimbal, and a remote control device then controls the camera. Since the gimbal can support multiple models of cameras, and the remote control device can only control simple functions of the camera but cannot have full control of the camera, the images captured by the camera hardly meet various needs of the user.

### SUMMARY

In accordance with the disclosure, there is provided a data conversion method applied to a data conversion device including receiving a camera control signal transmitted by a remote control device, converting a format of the camera control signal to a protocol format of a camera, and transmitting the converted camera control signal to the camera. The data conversion device is connected to a gimbal and the camera, and the gimbal is controlled by the remote control device.

Further, in accordance with the disclosure, there is provided a gimbal assembly including a gimbal, and a data conversion device placed on the gimbal. The data conversion device includes a first processor, and a first interface and a second interface, both connected to the first processor. The first interface is configured to be connected to the gimbal, and the gimbal is controlled by a remote control device; the second interface is configured to be connected to a camera; and the first processor is configured to, in response to receiving a camera control signal transmitted by the remote control device, convert a format of the camera control signal into a protocol format of the camera, and transmit the converted camera control signal to the camera via the second interface.

Further, in accordance with the disclosure, there is provided an imaging system including a gimbal, a camera mounted on the gimbal, and a data conversion device. The date conversion device includes a first processor, and a first interface and a second interface both connected to the first processor. The first interface is configured to be connected to the gimbal, and the gimbal is controlled by a remote control device; the second interface is configured to be connected to a camera; and the first processor is configured to, in response to receiving a camera control signal transmitted by the remote control device, convert a format of the camera control signal into a protocol format of the camera, and transmit the converted camera control signal to the camera via the second interface.

### BRIEF DESCRIPTION OF THE DRAWINGS

FIG. 1 is a schematic structural diagram of an imaging system consistent with embodiments of the present disclosure.

FIG. 2 is a schematic structural diagram of an unmanned aerial vehicle system consistent with embodiments of the present disclosure.

FIG. 3 is a flow chart of a data conversion method consistent with embodiments of the present disclosure.

FIG. 4 is a flowchart of a data conversion method consistent with embodiments of the present disclosure.

FIG. 5 is a flowchart of a photographing control method consistent with embodiments of the present disclosure.

FIG. 6 is a structural diagram of a data conversion device consistent with embodiments of the present disclosure.

FIG. 7 is a schematic structural diagram of a photographing control system consistent with embodiments of the present disclosure.

FIG. 8 is a schematic flowchart of a data conversion device consistent with embodiments of the present disclosure

FIG. 9 is a schematic structural diagram of a gimbal assembly consistent with embodiments of the present disclosure.

FIG. 10 is a schematic structural diagram of an unmanned aerial vehicle system according to another example embodiment.

### DETAILED DESCRIPTION OF THE EMBODIMENTS

The technical solutions in the embodiments of the present disclosure are clearly and completely described in the following with reference to the accompanying drawings in the embodiments of the present disclosure. It is obvious that the described embodiments are only a part of the embodiments of the present disclosure, and not all of the example embodiments. All other embodiments obtained by those skilled in the art based on the embodiments of the present disclosure without creative efforts are within the scope of the present disclosure.

A data conversion and photographing control method and a system, a gimbal assembly and an unmanned aerial vehicle (UAV) system of the present disclosure will be described in detail below with reference to the accompanying drawings. The features of the embodiments and embodiments described below may be combined with each other without conflict.

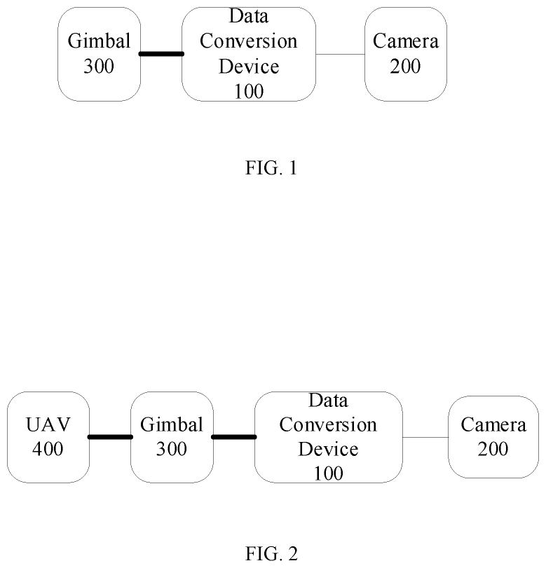

Referring to FIG. 1, an imaging system provided by an embodiment of the present disclosure may include: a gimbal 300, a camera 200 mounted on the gimbal 300, and a data conversion device 100 connected to the gimbal 300 and the camera 200. The imaging system may further include a remote control device (not shown in FIG. 1), and the remote control device is connected to the gimbal 300 to control the operation of the gimbal 300.

By mounting the camera 200 on the gimbal 300, the camera 200 is stabilized, so that the image captured by the camera 200 is fluent. By setting the data conversion device 100, the data transmitted from the gimbal 300 to the camera 200 or the camera 200 to the gimbal 300 is converted and then transmitted to the camera 200 or the gimbal 300, thereby solving the problem of incompatibility caused by the difference between the gimbal manufacturer and the camera manufacturer, such that the user can use a same remote control device to achieve the control of both the gimbal 300 and the camera 200, and the operation is convenient and quick.

In some embodiments, the gimbal 300 is a handheld gimbal.

In some embodiments, the gimbal 300 may be mounted on a movable device such as a UAV 400, a robot, a movable cart, etc. Referring to FIG. 2, the gimbal 300 is mounted on the UAV 400.

The remote control device may be a dedicated remote control or a smart terminal (e.g., mobile phone, tablet, etc.) with an APP installed. The remote control device can cooperate with the gimbal 300 and/or the UAV 400, and the remote control device can remotely control the gimbal 300 and/or the UAV 400 to control attitude switching of the gimbal 300 and/or control a flight of the UAV 400.

In the present embodiment, after the protocol format of converting the camera 200 is determined by the data conversion device 100, the type of the camera 200 is determined, and the type of the camera 200 needs to support the protocol format of the camera 200.

The processing of the data conversion device 100 and the gimbal 300 will be specifically described in the following embodiments.

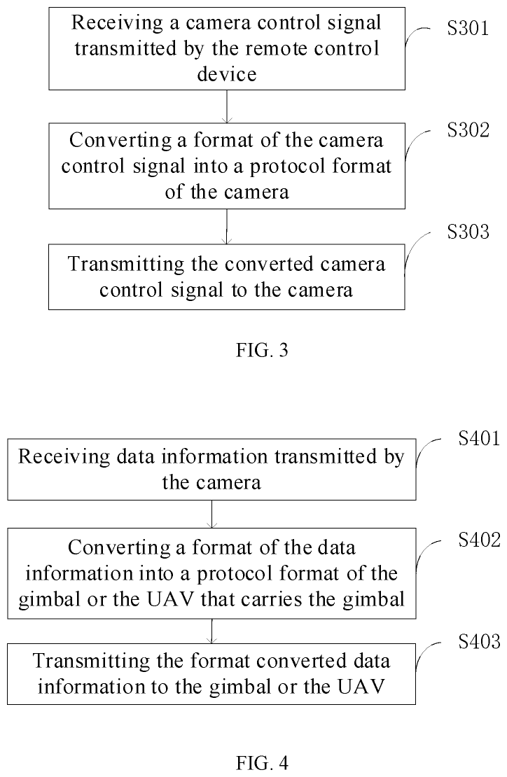

Referring to FIG. 3, the present disclosure provides a data conversion method applied to a data conversion device 100. The data conversion device 100 is connected to the gimbal 300 and the camera 200. The gimbal 300 and the camera 200 of the present embodiment implement a connection by the data device. The gimbal 300 is controlled by a remote control device.

The method may include the following steps:

S301: Receiving a camera control signal transmitted by the remote control device.

In some embodiment, the remote control device is connected to the gimbal 300. S301 includes receiving the camera control signal from the remote control device transmitted by the gimbal 300. The remote control device transmits the camera control signal to the gimbal 300, and the gimbal 300 transmits the camera control signal from the remote control device to the data conversion device 100.

In some embodiment, the gimbal 300 is mounted on a movable device such as a UAV 400 or a robot. For example, the gimbal 300 is mounted on the UAV 400, and the remote control device is connected to the UAV 400. Optionally, S301 includes: receiving the camera control signal from the remote control device transmitted by the UAV 400. The remote control device transmits the camera control signal to the UAV 400, and the UAV 400 transmits the camera control signal from the remote control device to the data conversion device 100. Optionally, S301 includes receiving the camera control signal from the remote control device sequentially transmitted by the UAV 400 and the gimbal 300. The remote control device transmits the camera control signal sequentially to the UAV 400 and the gimbal 300, then to the data conversion device 100.

The camera control signal may include at least one of: an action execution signal or a parameter setting signal. The action execution signal transmitted by the remote control device is transmitted to the camera 200 through the gimbal 300 and the data conversion device 100; or the UAV 400 and the data conversion device 100; or the UAV 400, the gimbal 300 and the data conversion device 100, such that the camera 200 can perform a function of the camera 200 corresponding to the action execution signal, and transmits the parameter setting signal transmitted by the remote control to the camera 200 by the gimbal 300 and the data conversion device 100; or the UAV 400 and the data conversion device 100; or the UAV, the gimbal 300 and the data conversion device 100, thereby changing the photographing parameters of the camera 200, and realizing a full control of the camera 200. The user only needs to operate the remote control device, which is convenient and quick, and no remote control for the camera 200 is further needed nor by manually adjusting the camera 200, such that the camera 200 can still be adjusted to have the required photographing parameters or actions during flight of the UAV 400 to obtain images that meet various needs of the user. It should be noted that other types of signals configured to control the camera 200 photographing may also be selected as the camera control signal.

The action execution signal may include a photographing instruction signal for instructing the camera 200 to perform a photographing function, or a focus signal for instructing the camera 200 to perform a focus function, or other types of motion execution signals. The user only needs to control the remote control device to instruct the camera 200 to realize the photographing or focusing function, which is convenient and quick.

The camera parameters (e.g., photographing parameters) corresponding to the parameter setting signal may include at least one of: a shutter control parameter, an aperture parameter, an exposure parameter, an exposure mode, a white balance parameter, a white balance mode, or an infinity and auto focus mode switching. The user only needs to control the remote control device to set the photographing parameters of the camera 200, which is convenient and quick.

S302: Converting a format of the camera control signal into a protocol format of the camera 200.

Step 302 converts the format of the camera control signal into the protocol format of the camera 200 by the data conversion device 100, thereby enabling the camera control signal to be recognized by the camera 200, and accordingly, to implement the control of the camera 200.

In some embodiments, a default protocol format of camera manufacturer may be selected as the protocol format of the camera 200 to realize the control of the camera 200 manufactured by the camera manufacturer. In this application scenario, the camera 200 of the same manufacturer can be directly replaced.

In some embodiments, a standard camera 200 protocol format may be selected as the protocol format of the camera 200. This application scenario is suitable for the camera 200 using the standard camera 200 protocol format, but in practice, the protocol format used by each camera manufacturer may vary widely and this application scenario is hardly applicable.

In some embodiments, a protocol format selection module may be arranged in the remote control device, and a protocol format of the camera 200 of a plurality of camera manufacturers or a standard camera 200 protocol format may be preset in the protocol format selection module. The user can directly select the protocol format of the current camera 200 in the protocol format selection module, and the remote control device transmits the protocol format of the current camera 200 selected by the user to the data conversion device 100, to indicate the currently supported protocol format of the camera 200 to the data conversion device 100.

Prior to S302, the method may further include: receiving a protocol format of the camera 200 transmitted by the remote control device to instruct the data conversion device 100 to convert the camera control signal received by the data conversion device 100 into the received protocol format of the camera 200.

S303: Transmitting the converted camera control signal to the camera 200.

After the data conversion device 100 converts the camera control signal into the protocol format of the camera 200, the converted camera control signal is transmitted to the camera 200. The camera 200 can recognize the camera control signal after the format conversion, thereby performing a corresponding action or performing a photographing parameter setting.

In some embodiment of the present disclosure, the gimbal 300 and the camera 200 are connected to the data conversion device 100, and the camera control signal transmitted by the remote control device are converted into the protocol format of the camera 200 by the data conversion device 100, which can overcome a problem of incompatibility between a gimbal manufacturer and the camera manufacturer, resulting in a more comprehensive camera 200 photographing for a better imaging experience. Moreover, the camera control signal transmitted by the camera 200 is transmitted by the gimbal 300, and processed by the data conversion device 100, so that the gimbal 300 and the camera 200 are controlled by the same remote control device, and the user operation is more convenient.

Referring to FIG. 4, the method may further include:

S401: Receiving data information transmitted by the camera 200.

In some embodiment, the data information includes at least one of camera parameters (e.g., photographing parameters of the camera 200) or image information captured by the camera 200. The camera parameters may include parameters such as a shutter control parameter, an aperture parameter, an exposure parameter, an exposure mode, a white balance parameter, a white balance mode, or infinity and auto focus mode switching. The image information refers to the number of images taken by the camera 200, the size of the image, etc., and does not include the content of the image. This is because the content of the image is large, and the communication speed may be slow when the image is transmitted by the data conversion device 100, which cannot meet a requirement of real-time transmission. Optionally, the camera 200 is connected to the gimbal 300 or the UAV 400 that carries the gimbal 300 by an image transmission line (e.g., HDMI line, High Definition Multimedia Interface), and the image captured by the camera 200 (that is, the content of the image) is transmitted to the gimbal 300 or the UAV 400 on which the gimbal 300 is mounted by the image transmission line, to ensure real-time transmission of images.

Prior to S401, the method further includes: Transmitting a reading command to the camera 200 to trigger the camera 200 to return data information for a reading instruction. The reading instruction includes a type of data information to be read, in order to timely obtain camera parameters or image information captured by the camera 200.

In some embodiment, before transmitting the reading command to the camera 200, the method further includes: receiving a camera data reading signal transmitted by the remote control device. The camera data reading signal is configured to indicate corresponding data information the camera 200 returns. The data conversion device 100 transmits a reading command to the camera 200 after it receives the camera data reading signal transmitted by the remote control device, so that the camera parameters or the image information captured by the camera 200 can be read according to the user's needs, and the control is more flexible.

In some embodiment, transmitting a reading command to the camera 200 includes: transmitting a reading command to the camera 200 according to a preset time rule. Optionally, the preset time rule is aperiodic, thereby improving the timeliness of data processing by the data conversion device 100.

S402: Converting a format of the data information into a protocol format of the gimbal 300 or the UAV 400 that carries the gimbal.

In some embodiment, the remote control device is directly connected to the gimbal 300. For example, the gimbal 300 is a handheld gimbal 300. S402 includes: converting the format of the data information into a protocol format of gimbal 300. The format of the data information is converted into the protocol format of the gimbal 300 by the data conversion device 100, so that the data information returned by the camera 200 can be recognized by the gimbal 300 and transmitted to the remote control device, so that the user can timely obtain the camera parameters or the image information captured by the camera 200, etc., thereby guiding the user to further control the camera 200.

In some embodiment, the gimbal 300 is mounted on a movable device such as a UAV 400 or a robot. For example, the gimbal 300 is mounted on the UAV 400, and the remote control device is connected to the UAV 400. S402 includes: converting the format of the data information into a protocol format of the UAV 400. The format of the data information is converted into the protocol format of the UAV 400 by the data conversion device 100, so that the data information returned by the camera 200 can be recognized by the UAV 400 and transmitted to the remote control device, so that the user timely obtains the camera parameters or image information captured by the camera 200, thereby guiding the user to further control the camera 200.

Optionally, the protocol format of the gimbal 300 is the same as the protocol format of the UAV 400.

S403: Transmitting the format converted data information to the gimbal 300 or the UAV 400.

In some embodiments, the gimbal 300 is a handheld gimbal 300, and the data conversion device 100 directly transmits the converted format data information to the gimbal 300.

In some embodiments, the gimbal 300 is mounted on the UAV 400. Optionally, the data conversion device 100 is connected to the UAV 400, and the data conversion device 100 directly transmits the converted format data information to the UAV 400. Optionally, the data conversion device 100 is connected to the UAV 400 via the gimbal 300. Transmitting the converted formatted data information to the UAV 400 includes: transmitting the converted format data information to the UAV 400 via the gimbal 300.

In some examples, the method may further include: receiving location information transmitted by the gimbal 300 and transmitting a most recently received location information to the camera 200. For the location information received by the data conversion device 100 and transmitted by the gimbal 300, the gimbal 300 may actively transmit its real-time location information to the data conversion device 100, or the remote control device may instruct the gimbal 300 to transmit its location information to the data conversion device 100. Optionally, a location parameter setting button is disposed on the remote control device, and when the user presses the location parameter setting button, the remote control device transmits a location parameter setting signal to the gimbal 300. After receiving the location parameter setting signal transmitted by the remote control device, the gimbal 300 transmits its location information to the data conversion device 100.

In some examples, the method may further include: receiving location information transmitted by the UAV 400 and transmitting the most recently received location information to the camera 200. The location information transmitted by the UAV 400 and received by the data conversion device 100, may be the location information of the UAV 400 transmitted to the data conversion device 100 after the gimbal 300 actively obtains the location information of the UAV 400, or may be the location information of the UAV 400 transmitted by the gimbal 300 to the data conversion device 100 after the remote control device instructs the UAV 400 to transmits its location information to the gimbal 300, or may be the real-time location information actively transmitted by the UAV 400 to the data conversion device 100. Optionally, a location parameter setting button is disposed on the remote control device, and when the user presses the location parameter setting button, the remote control device transmits the location parameter setting signal to the UAV 400. After receiving the location parameter setting signal transmitted by the remote control device, the UAV 400 transmits its location information to the gimbal 300, and the gimbal 300 transmits the location information of the UAV 400 to the data conversion device 100, or the UAV 400 directly transmits its location information to the data conversion device 100 without the transmission of the gimbal 300.

In this embodiment, transmitting the last received location information to the camera 200 includes: saving the last received location information to an image file format (EXIF) of the camera 200, so that the camera real-time location information can be displayed in the images captured by the camera 200.

The location information may be obtained by the gimbal 300 or the UAV 400 by means of GPS or other navigation, or may be set by a user.

The location information may include a real-time location of the gimbal 300 or the camera 200, and may also include a current date, etc.

In some embodiments, the method may further include: if a triggering condition is met, transmitting a user prompt to the remote control device. The user prompt may include a prompt for prohibiting photographing, a prompt for prohibiting focus or a prompt for enabling focus, etc., to prevent the user from mis-operations or prompt the user to operate the camera 200 functions.

In some examples, the user prompt is a prompt for prohibiting photographing. The triggering condition is that a number of storable images of the camera 200 is less than or equal to a preset number is detected. Optionally, the preset number is 0. When the data conversion device 100 detects that the number of images that the camera 200 can store is equal to 0, the prompt for prohibiting photographing is sent to the user, to prevent the user from misoperating the photographing function of the camera 200. A photographing function button may be disposed on the remote control device. When the camera 200 can perform the photographing function, the photographing function button is in an active state. After the remote control device receives the prompt for prohibiting photographing, the photographing function button is set to a state in which photographing is prohibited, to prevent the user from misoperating the photographing function button. Optionally, the user prompt is a prompt for enabling photographing. When the data conversion device 100 detects that the number of storable images of the camera 200 is greater than 0, a prompt for enabling photographing is sent to the user. After the remote control device receives the prompt for enabling photographing, the photographing function button is restored to the active state.

In some examples, the user prompt is the prompt for prohibiting photographing. The triggering condition is that the camera 200 is detected to perform the focus function. When the camera 200 performs the focus function, if an action execution signal directing the camera 200 to perform the photographing function is received, the camera 200 may falter. Optionally, a photographing function button may be disposed on the remote control device. When the camera 200 can perform the photographing function, the photographing function button is in an active state. After the data conversion device 100 detects that the camera 200 performs the focus function, the prompt for prohibiting photographing is sent to the remote control device. After the remote control device receives the prompt for prohibiting photographing, the photographing function button is set to a state in which photographing is prohibited, to prevent the user from mis-operating the photographing function button. Optionally, the user prompt is a prompt for enabling. After the data conversion device 100 receives a focus ending signal transmitted by the camera 200, the prompt for enabling photographing is sent to the user. After the remote control device receives the prompt for enabling photographing, the photographing function button is restored to an active state.

In some examples, the user prompt is the prompt for prohibiting focus. The triggering condition is that the camera 200 is detected to perform the focus function. When the camera 200 performs the photographing function, if an action execution signal directing the camera 200 to perform the focus function is received, the camera 200 may be delayed. Optionally, a focus function button may be disposed on the remote control device. After the remote control device receives the prompt for prohibiting focus, the focus function button is set to a state in which focus is prohibited, to prevent the user from mis-operating the focus function button.

In some examples, the user prompt is the prompt for enabling focus. The triggering condition is, after the prompt for prohibiting focus is transmitted to the remote control device, a photographing ending signal transmitted by the camera 200 is received. After the data conversion device 100 receives the photographing end signal transmitted by the camera 200, the prompt for enabling focus is sent to the user. After the remote control device receives the prompt for enabling focus enable, the focus function button is restored to the active state.

In some embodiments, the method may further include: in response to detecting that the gimbal 300 is disconnected from the data conversion device 100, controlling a status indicator, such as a status indicator light, of the data conversion device 100 to be in a first state, thereby guiding the user to complete connection between the gimbal 300 and the data conversion device 100 by communication link. This guiding method is relatively intuitive and efficient. In some embodiment of the present disclosure, the disconnected state of the gimbal 300 and the data conversion device 100 is that the communication link between the gimbal 300 and the data conversion device 100 is interrupted. Optionally, the data conversion device 100 performs real-time detection to a first interface 102 of the data conversion device 100 for connecting to the gimbal 300, and reads a state of a device connected to the first interface 102 and the device information so as to detect the disconnection of the communication link between the gimbal 300 and the data conversion devices 100, to help the user quickly set up the system.

In some embodiments, the method may further include: in response to detecting that the camera 200 is disconnected from the data conversion device 100, controlling the status indicator of the data conversion device 100 to be in a second state, thereby guiding the user to complete the connection between the camera 200 and the data conversion device 100 by communication link. This guiding method is relatively intuitive and efficient. In some embodiment of the present disclosure, the disconnected state of the camera 200 and the data conversion device 100 is that the communication link between the camera 200 and the data conversion device 100 is interrupted. Optionally, the data conversion device 100 performs a real-time detection to a second interface 103 of the data conversion device 100 for connecting to the gimbal 300, and reads the state of a device connected to the second interface 103 and the device information, so as to detect the disconnection of the communication link between the camera 200 and the data conversion devices 100, to help the user quickly set up the system.

In some embodiments, the gimbal 300 is mounted on the UAV 400. The method may further include: in response to detecting that the gimbal 300 is disconnected from the UAV 400, controlling the status indicator of the data conversion device 100 to be in a third state, thereby guiding the user to complete the connection between the gimbal 300 and the UAV 400 by the communication link. This guiding method is relatively intuitive and efficient. In some embodiment of the present disclosure, the disconnected state of the gimbal 300 and the UAV 400 is that the communication link between the gimbal 300 and the UAV 400 is interrupted. Optionally, after the gimbal 300 detects that the communication link between the gimbal 300 and the UAV 400 is interrupted, a signal indicating that the gimbal 300 and the UAV 400 are in a disconnected state is transmitted to the data conversion device 100, and the data conversion device 100 guides the user to complete the connection of the communication link between the gimbal 300 and the UAV 400 by controlling the status indicator. It should be noted that the data conversion device 100 can detect that the gimbal 300 and the UAV 400 are in a disconnected state and the communication link between the gimbal 300 and the data conversion device 100 is in a connected state.

It should be noted that the first state, the second state, and the third state of the present disclosure are all different, thereby guiding a mounting of the gimbal 300 and the data conversion device 100, the camera 200 and the data conversion device 100, and the UAV 400 and the gimbal 300, to solve the problem of quickly detecting each communication link. For example, the first state, the second state and the third state may be distinguished by illuminating color of the status indicator; or the first state, the second state and the third state may be distinguished by illuminating duration of the status indicator; the first state, the second state and the third state may also be distinguished by blinking state of the status indicator; or, the first state, the second state and the third state may be distinguished by a combination of at least two of: the illuminating color, the illuminating duration, or the blinking state of the status indicator. Of course, the first state, the second state and the third state may also be distinguished by other means.

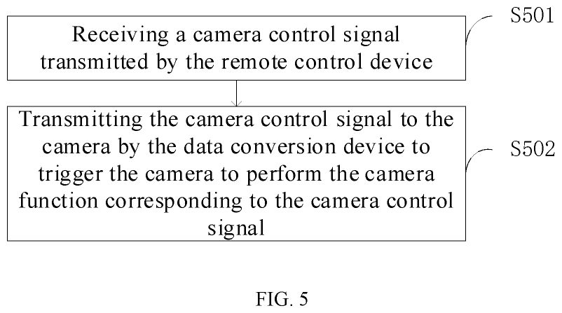

Referring to FIG. 5, a photographing control method according to some embodiment of the present disclosure is applied to the gimbal 300. The gimbal 300 is connected to the data conversion device 100. The data conversion device 100 is also connected to the camera 200. The gimbal 300 and the camera 200 of the present embodiment implement a connection by both being connected to the data device. The gimbal 300 is controlled by a remote control device.

The method may include the following steps:

S501: Receiving a camera control signal transmitted by the remote control device.

In some embodiment, the remote control device is directly connected to the gimbal 300, and the gimbal 300 directly receives the camera control signal transmitted by the remote control device.

In some embodiment, the gimbal 300 is mounted on a movable device such as a UAV 400 or a robot. For example, the gimbal 300 is mounted on the UAV 400, and the remote control device is connected to the UAV 400. Optionally, S501 includes: receiving the camera control signal transmitted by the remote control device from the UAV 400. The remote control device transmits the camera control signal to the UAV 400, and the camera control signal from the remote control device is transmitted from the UAV 400 to the gimbal 300.

The camera control signal may include at least one of: an action execution signal or a parameter setting signal. The action execution signal transmitted by the remote control device is transmitted to the camera 200 by the gimbal 300 and the data conversion device 100, or the UAV 400, the gimbal 300 and the data conversion device 100, so that the camera 200 can perform the corresponding camera 200 functions to the action execution signal, and transmits the parameter setting signal of the remote control to the camera 200 by the gimbal 300 and the data conversion device 100, or the UAV 400, the gimbal 300 and the data conversion device 100, thereby changing the photographing parameters of the camera 200, to realize a full control of the camera 200. The user only needs to operate the remote control device, which is convenient and quick, and the camera 200 may be adjusted without additionally adding a remote control for the camera 200 or manually adjusting the camera 200, so that during the flight of the UAV 300, the camera 200 can still be adjusted to the required photographing parameters or actions to get images that meet the various needs of the user. It should be noted that select other types of signals configured to control the photographing of the camera 200 may also be selected as the camera control signal.

The action execution signal may include a camera instruction signal configured to instruct the camera 200 to perform the photographing function, a focus signal configured to instruct the camera 200 to perform the focus function, and other types of action execution signals. The user only needs to control the remote control device to instruct the camera 200 to realize the photographing or focusing function, which is convenient and quick.

The camera parameters corresponding to the parameter setting signal may include at least one of: a shutter control parameter, an aperture parameter, an exposure parameter, an exposure mode, a white balance parameter, a white balance mode, or an infinity and auto focus mode switching. The user only needs to control the remote control device to set respective photographing parameters of the camera 200, which is convenient and quick.

S502: Transmitting the camera control signal to the camera 200 by the data conversion device 100 to trigger the camera 200 to perform the camera 200 function corresponding to the camera control signal.

The data conversion method for the camera control signal by the data conversion device 100 can be referred to the foregoing described data conversion method, and details are not described herein again.

In the embodiment of the present disclosure, the gimbal 300 and the camera 200 are connected to the data conversion device 100, and the camera control signal transmitted by the remote control device are converted into the protocol format of the camera 200 by the data conversion device 100, which can overcome the problem of incompatibility between the gimbal manufacturer and the camera manufacturer, so that the photographing of the camera 200 can be more comprehensively controlled, to obtain a better imaging experience. Moreover, the camera control signal captured by the camera 200 are transmitted by the gimbal 300, and processed by the data conversion device 100, so that the gimbal 300 and the camera 200 are controlled by the same remote control device, and the user operation is more convenient.

In some examples, the method may further include: transmitting the location information of the gimbal 300 to the data conversion device 100. The gimbal 300 may actively transmit the real-time location information to the data conversion device 100, or the remote control device may instruct the gimbal 300 to transmit its location information to the data conversion device 100. Optionally, a location parameter setting button is disposed on the remote control device. When the user presses the location parameter setting button, the remote control device transmits the location parameter setting signal to the gimbal 300, and after the gimbal 300 receives the location parameter setting signal transmitted by the remote control device, its location information is transmitted to the camera 200.

In some examples, the gimbal 300 is mounted on the UAV 400. The method may further include: transmitting the location information of the UAV 400 to the data conversion device 100. After the gimbal 300 actively obtains the location information of the UAV 400, the location information of the UAV 400 may be transmitted to the data conversion device 100; or the remote control device instructs the UAV 400 to transmit its location information to the gimbal 300, and the gimbal 300 transmits the location information of the UAV 400 to the data conversion device 100. Optionally, a location parameter setting button is disposed on the remote control device. When the user presses the location parameter setting button, the remote control device transmits the location parameter setting signal to the UAV 400, and after the UAV 400 receives the location parameter setting signal transmitted by the remote control device, its location information is transmitted to the gimbal 300, and the location information of the UAV 400 is transmitted from the gimbal 300 to the camera 200.

The location information may be obtained by the gimbal 300 or the UAV 400 by means of GPS or other navigation, or may be set by a user.

The location information may include a real-time location of the gimbal 300 or the camera 200, and may also include a current date, etc.

The method may further include: receiving a camera data reading signal transmitted by the remote control device, and transmitting the camera data reading signal to the data conversion device 100 to trigger the data conversion device 100 to acquire corresponding data information from the camera 200 and read camera parameters or image information captured by the camera 200 according to the user's needs, and the control is relatively flexible. The camera data reading signal is configured to instruct the camera 200 to return the corresponding data information.

The photographing control method can be further explained with reference to the foregoing described data conversion method.

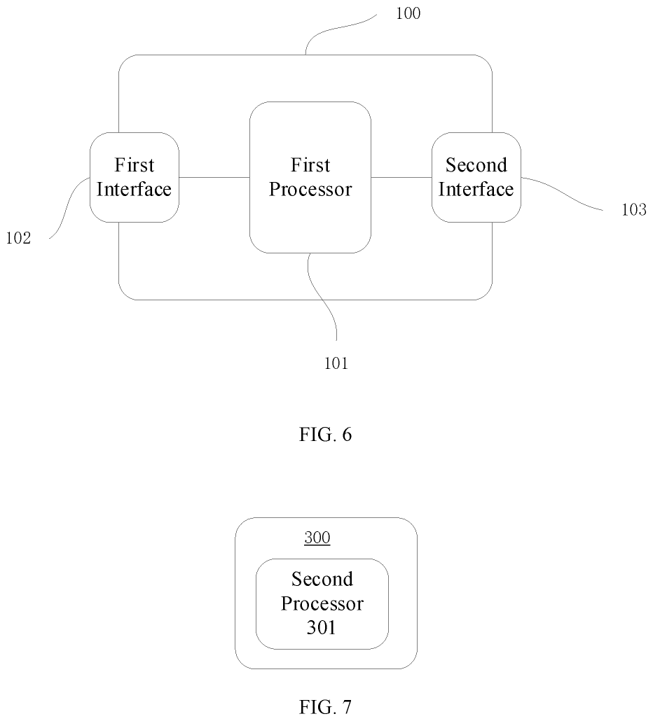

Referring to FIG. 6, some embodiment of the present disclosure provides a data conversion system. The data conversion system is connected to a gimbal and a camera, and the gimbal is controlled by a remote control device.

Referring to FIG. 6, the data conversion system may include a first processor 101. The first processor 101 may be connected to the gimbal 300 and the camera 200. The first processor 101 may also be connected to the UAV 400.

In this embodiment, the first processor 101 includes one or a plurality of processors, that operates separately, or in combination, to perform the data conversion method described above.

Referring to FIG. 7, some embodiment of the present disclosure provides a photographing control system that may be applied to the gimbal 300. Referring to FIG. 7, the photographing control system may include a second processor 301.

In this embodiment, the second processor 301 includes one or a plurality of processors, that operates separately, or in combination, to perform the steps of the photographing control method described above.

In some embodiment, the structure of the data conversion device 100 is specifically described.

Referring to FIG. 6, a data conversion device 100 is provided by some embodiment of the present disclosure. The data conversion device 100 may include a first processor 101, a first interface 102 and a second interface 103 which are connected to the first processor 101, respectively.

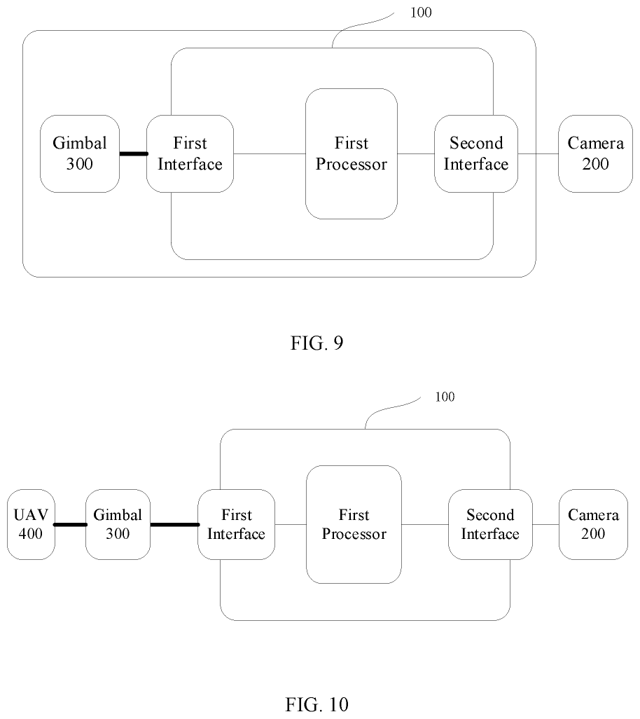

Referring to FIG. 9, the first interface 102 may be connected to the gimbal 300, and the second interface 103 may be connected to the camera 200. In some examples, the first interface 102 and the second interface 103 may be hardware interfaces, and may be connected to the gimbal 300 or the camera 200 by physical connection. In other examples, the first interface 102 and the second interface 103 may be application interfaces.

The structure of the data conversion device 100 of the present disclosure will be further described by taking the first interface 102 and the second interface 103 being hardware interfaces as an example.

The first interface 102 matches the interface type of an external interface of the gimbal 300. For example, when the interface of the gimbal 300 is a bus interface (for example, a CAN bus interface), the first interface 102 is matched bus interface. The interface type for the first interface 102 is not enumerated here.

The second interface 103 matches the interface type of an external interface of the camera 200. For example, when an external interface of the camera 200 is a Type C interface, the second interface 103 is an interface that matches the Type C interface.

Optionally, the signal line between the second interface 103 and the camera 200 has two interfaces, one of which matches the second interface 103 and the other that matches an external interface of the camera 200. For example, the second interface 103 is a USB interface, and an external interface of the camera 200 is a Type C interface, and two interfaces connecting the signal lines of the camera 200 and the second interface 103 can be respectively matched with the USB interface and the Type C interface, thereby enabling a communication link between the camera 200 and the second interface 103. The interface type for the second interface 103 is not enumerated here.

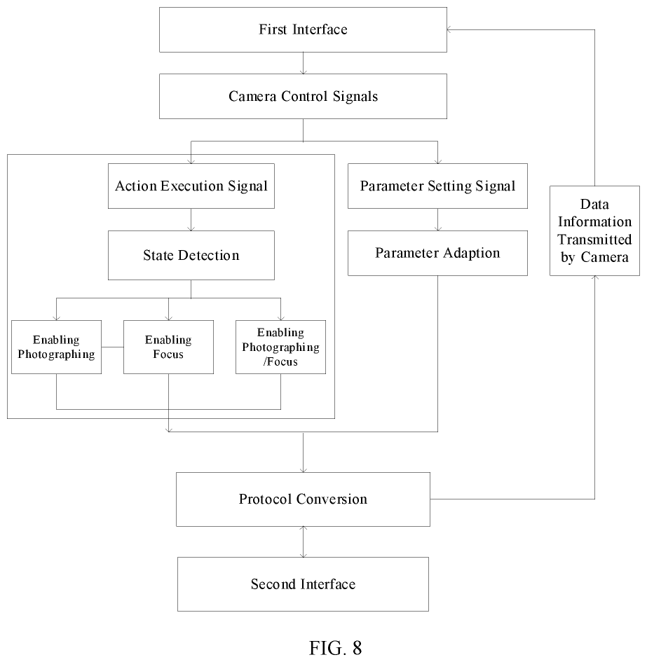

Referring to FIG. 8, the first processor 101 is configured to, in response to receiving the camera control signal transmitted by the remote control device, convert a format of the camera control signal into a protocol format of the camera 200, which is then transmitted to the camera 200 from the second interface 103. After processed by the first processor 101, the camera control signal transmitted by the remote control device can be recognized by the camera 200, thereby controlling the camera 200 to perform the camera 200 functions corresponding to the camera control signal, to meet the photographing needs of the user.

It should be noted that, in the present disclosure, the remote control device may control the operation of the gimbal 300 and/or the movable device (e.g., the UAV 400, the robot, etc.) for carrying the gimbal 300. Optionally, the remote control device is a dedicated remote controller or a smart terminal (e.g., a mobile phone, a tablet, etc.) installed with an APP.

The camera control signal may include at least one of: an action execution signal, or a parameter setting signal. The action execution signal transmitted by the remote control device is transmitted to the camera 200 by the gimbal 300 and the data conversion device 100, or, the UAV 400 and the data conversion device 100, or, the UAV 400, the gimbal 300 and the data conversion device 100, such that the camera 200 can perform the camera 200 functions corresponding to the action execution signal, and transmits the parameter setting signal from the remote control device to the camera 200, by the gimbal 300 and the data conversion device 100, or, the UAV 400 and the data conversion device 100, or, the UAV 400, the gimbal 300 and the data conversion device 100, thereby changing the photographing parameters of the camera 200, and realizing the full control of the camera 200. The user only needs to operate the remote control device, which is convenient and quick, and no additional remote control for the camera 200 is needed nor by manually adjusting the camera 200, such that during the flight of the UAV 400, the camera 200 can still be adjusted to the required photographing parameters or actions, to obtain images that meet the various needs of the user. It should be noted that other types of signals configured to control the photographing of the camera 200 may also be selected.

The action execution signal may include: a photographing instruction signal for instructing the camera 200 to perform a photographing function, a focus instruction signal for instructing the camera 200 to perform a focus function, and other types of action execution signals. The user only needs to control the remote control device to instruct the camera 200 to realize the photographing or focusing function, which is convenient and quick.

The camera parameters corresponding to the parameter setting signal may include at least one of: a shutter control parameter, an aperture parameter, an exposure parameter, an exposure mode, a white balance parameter, a white balance mode, or an infinity and auto focus mode switching. The user only needs to control the remote control device to set the respective photographing parameters of the camera 200, which is convenient and quick.

Referring also to FIG. 8, the first processor 101 is further configured to, in response to receiving the data information transmitted by the camera 200, convert the format of the data information into protocol format of the gimbal 300 or the UAV 400, and transmitted from the first interface 102 to the gimbal 300 or the UAV 400. The data information converted by the data conversion device 100 is transmitted reverse to the remote control device, and can be displayed on the remote control device for the user to view, thereby better grasping the current photographing parameters of the camera 200 or the captured image information.

The data information includes at least one of: camera parameters (e.g., photographing parameters of the camera 200), or image information captured by the camera 200, etc. The camera parameters may include parameters such as a shutter control parameter, an aperture parameter, an exposure parameter, an exposure mode, a white balance parameter, a white balance mode, or an infinity and auto focus mode switching. The image information refers to the number of images captured by the camera 200, the size of the image, etc., and does not include the content of the image. This is because the content of the image is large, and the communication speed may be slow when the image is transmitted by the data conversion device 100, which cannot meet the requirement of real-time transmission.

The data conversion device 100 may further include a status indicator to guide the user to mount the gimbal 300 and the data conversion device 100, the camera 200 and the data conversion device 100, and the gimbal 300 and the UAV 400.

The status indicator is electrically connected to the first processor 101, and the first processor 101 can control the operation of status indicator, based on the connecting state of at least one of: the gimbal 300 and the first interface 102, the camera 200 and the second interface 103, or the gimbal 300 and the UAV 400.

In some embodiment, when the first processor 101 detects that the gimbal 300 is disconnected from the first interface 102 (e.g., the communication link between the gimbal 300 and the first interface 102 is disconnected), the status indicator is controlled to be in the first state. When the first processor 101 detects that the camera 200 is disconnected from the second interface 103 (e.g., the communication link between the camera 200 and the second interface 103 is disconnected), the status indicator is controlled to be in the second state. When the first processor 101 detects that the gimbal 300 is disconnected from the UAV 400 (e.g., the communication link between the gimbal 300 and the UAV 400 is disconnected), the status indicator is controlled to be the third state. In this embodiment, the first state, the second state, and the third state are all different, thereby guiding the mounting of the gimbal 300 and the data conversion device 100, the camera 200 and the data conversion device 100, the UAV 400 and the gimbal 300, to implement fast detection of each communication link.

In some embodiments, there is one status indicator. In these embodiments, when the gimbal 300 is connected to the first interface 102, the first processor 101 can detect the connecting state of the communication link between the gimbal 300 and the UAV 400. The first state, the second state and the third state may be distinguished by the illuminating color of the status indicator; the first state, the second state and the third state may also be distinguished by the illuminating duration of the status indicator; or, the first state, the second state and the third state may be distinguished by the blinking state of the status indicator; or, the first state, the second state and the third state may be distinguished by a combination of at least two of: the illuminating color, the illuminating duration, the blinking state of the status indicator. Of course, the first state, the second state and the third state may also be distinguished by other means.

In some embodiments, there may be three status indicators, configured for indicating the connecting state of the gimbal 300 and the first interface 102, the connecting state of the camera 200 and the second interface 103, and connecting state of the gimbal 300 and the UAV 400. Optionally, when the gimbal 300 is disconnected from the first interface 102, a corresponding status indicator does not operate. When the gimbal 300 is connected to the first interface 102, the corresponding status indicator is luminated. Optionally, when the camera 200 is disconnected from the second interface 103, a corresponding status indicator does not operate. When the camera 200 is connected to the second interface 103, the corresponding status indicator is luminated. Optionally, when the gimbal 300 is disconnected from the UAV 400, a corresponding status indicator does not operate. When the gimbal 300 is connected to the UAV 400, the corresponding status indicator is luminated.

In some embodiments, referring to FIG. 10, the gimbal 300 is mounted on the UAV 400, and the first processor 101 receives the camera control signal transmitted by the remote control device sequentially from the UAV 400 and the gimbal 300. The gimbal 300 and the camera 200 are connected to the data conversion device 100, and the camera control signal transmitted by the remote control device is converted into the protocol format of the camera 200 by the data conversion device 100, which can overcome the problem of incompatibility between the gimbal manufacturer and the camera manufacturer, so that the photographing of the camera 200 can be more comprehensively controlled, to obtain a better imaging experience. Moreover, the camera control signal captured by the camera 200 are transmitted the UAV 400 and the gimbal 300, and processed by the data conversion device 100, so that the UAV 400, the gimbal 300, and the camera 200 are controlled by the same remote control device, and the user operation is more convenient. Optionally, the protocol format of the UAV 400 is the same as the protocol format of the gimbal 300. Optionally, the gimbal 300 and the UAV 400, the gimbal 300 and the first interface 102 are all based on bus communication.

In some embodiments, the first processor 101 receives camera control signal by the gimbal 300 from the remote control device. In these embodiments, the remote control device implements data transmission with the data conversion device 100 through the connection to the gimbal 300. If the gimbal 300 is mounted on the UAV 400, the remote control device can also be connected to the UAV 400, to realizing the control of the UAV 400. By the same remote control device, the control of the UAV 400 and the gimbal 300 can be realized, and the control of the camera 200 can also be realized. Accordingly, the operation is more convenient, and the control of the camera 200 is more comprehensive to obtain a better photographing experience.

In some embodiments, the first processor 101 receives camera control signal transmitted by the UAV 400 from the remote control device. In these embodiments, the first processor 101 is connected to the UAV 400, and the remote control device implements data transmission with the data conversion device 100 by the UAV 400. By the same remote control device, the control of the UAV 400 can be realized, the control of the camera 200 can also be realized. Accordingly, the operation is more convenient, and the control of the camera 200 is more comprehensive to obtain a better photographing experience.

In some other examples, those skilled in the art can implement the data conversion function of the data conversion device 100 by means of a dedicated chip. The dedicated chip may be an application-specific integrated circuit (ASIC) chip, or a programmable device such as a field-programable gate array (FPGA). The functions of the data conversion device 100 can be implemented by one chip, or different portions of the functions can be implemented by different chips. The chip can implement corresponding functions through software programs, and can also implement corresponding functions through hardware forms such as circuits.

In some embodiments, various application scenarios based on the structure of the data conversion device 100 are specifically described.

Referring to FIG. 9, some embodiment of the present disclosure provides a gimbal assembly, which may include the gimbal 300 and the data conversion device 100 of the above Embodiment Five. The first interface 102 of the data conversion device 100 is connected to the gimbal 300, and the second interface 103 of the data conversion device 100 is configured to be connected to the camera 200, and by connection to the data conversion device 100, the problem of incompatibility between the gimbal manufacturer and the camera manufacturer can be overcome, so that the photographing of the camera 200 can be more comprehensively controlled, to obtain a better photographing experience, and the user operation is more convenient.

The data conversion device 100 may be fixed to the gimbal 300. Specifically, the data conversion device 100 may be fixed to the gimbal 300 by means of plugging, bonding, or threading, etc. The present disclosure does not specifically limit the fixing manner of the data conversion device 100 to the gimbal 300.

The gimbal 300 can cooperate with a remote control device, and the user can control the gimbal 300 and the camera 200 by the remote control device, which is convenient and quick. Optionally, the gimbal 300 is a handheld gimbal 300.

Referring to FIG. 1, some embodiment of the present disclosure provides an imaging system, which may include a gimbal 300, a camera 200 mounted on the gimbal 300, and a data conversion device 100. The first interface 102 of the data conversion device 100 is connected to the gimbal 300, and the second interface 103 of the data conversion device 100 is connected to the camera 200. Through the connection of the data conversion device 100, the problem of incompatibility between the gimbal manufacturer and the camera manufacturer can be overcome, so that the photographing of the camera 200 can be more comprehensively controlled, to obtain a better photographing experience, and the user operation is more convenient.

The data conversion device 100 may be fixed to the gimbal 300, may be fixed to the camera 200, or may be fixed to a movable device (e.g., a UAV 400, a robot, etc.) on which the gimbal 300 is mounted. Specifically, the data conversion device 100 can be fixed to the gimbal 300, the camera 200, or the movable device by means of plugging, bonding, or threading. The present disclosure does not specifically limit the fixing manner of the data conversion device 100 to the gimbal 300, the camera 200 or a movable device.

The gimbal 300 can cooperate with a remote control device, and the user can control the gimbal 300 and the camera 200 by the remote control device, which is convenient and quick. Optionally, the gimbal 300 is a handheld gimbal 300.

Referring to FIGS. 2 and 10, some embodiment of the present disclosure provides a UAV system, which may include a remote control device, the UAV 400, and the gimbal 300 mounted on the UAV 400, the camera 200 mounted on the gimbal 300 and the data conversion device 100 described above.

The remote control device is connected to the UAV 400, and the UAV 400 is connected to the gimbal 300. The user can control the UAV 400, and/or the gimbal 300, and the camera 200 by the remote control device, which is convenient and quick.

In some embodiments, the UAV 400, the data conversion device 100, and the gimbal 300 are each based on a bus communication connection.

The type of bus can be selected as needed, for example, a CAN bus.

The first interface 102 of the data conversion device 100 is connected to the gimbal 300, and the second interface 103 of the data conversion device 100 is connected to the camera 200. By the connection to the data conversion device 100, the problem of incompatibility between the gimbal manufacturer and the camera manufacturer can be overcome, so that the photographing of the camera 200 can be more comprehensively controlled, to obtain a better photographing experience, and the user operation is more convenient.

The data conversion device 100 may be fixed to the gimbal 300, may be fixed to the camera 200, or may be fixed to the UAV 400 on which the gimbal 300 is mounted. Specifically, the data conversion device 100 can be fixed to the gimbal 300, the camera 200, or the UAV 400 by means of plugging, bonding, or threading. The present disclosure does not specifically limit the fixing manner of the data conversion device 100 to the gimbal 300, the camera 200 or the UAV.

Some embodiment of the present disclosure provides a computer storage medium, the computer storage medium stores program instructions, the program executes the data conversion method, or the photographing control method described above.

For the device embodiment, since it essentially corresponds to the method embodiment, reference may be made to a related part of the description of the method embodiment. The device embodiments described above are merely illustrative, wherein the units described as separate components may or may not be physically separate, and the components displayed as units may or may not be physical units, that is, may be located at the same place, or may be distributed to multiple network units. Some or all of the modules may be selected according to actual needs to achieve the purpose of the solution of some embodiments. Those of ordinary skill in the art can understand and implement without any creative effort.

The description of the “specific examples”, or “some examples”, etc., are intended to include the particular features, structures, materials or features described in association with the described embodiments or examples in the at least one embodiment or example. In the present specification, the schematic representation of the above terms does not necessarily mean the same embodiment or example. Furthermore, the specific features, structures, materials, or characteristics described may be combined in a suitable manner in any one or more embodiments or examples.

Any process or method description in the flowcharts or otherwise described herein can be understood as a module, segment, or portion representing code that includes one or more executable instructions for implementing the steps of a particular logical function or process, and the scope of the preferred embodiments of the present disclosure includes additional implementations, in which the functions may be performed in a substantially simultaneous manner or in the reverse order, depending on the order in which they are illustrated. This should be understood by those skilled in the art to which the embodiments of the present disclosure pertain.

The logic and/or steps represented in the flowchart or otherwise described herein, for example, may be considered as an ordered list of executable instructions for implementing logical functions, and may be implemented in any computer readable medium, and used by an instruction execution system, apparatus or device (e.g., a computer-based system, a system including a processor, or other system that can receive instructions and execute instructions from the instruction execution system, apparatus, or device), or used in conjunction with the instruction execution system, apparatus or device. For the purposes of this specification, a “computer-readable medium” can be any apparatus that can contain, store, communicate, propagate, or transport a program for use in an instruction execution system, apparatus, or device, or in conjunction with the instruction execution system, apparatus, or device. More specific examples (non-exhaustive list) of computer readable medium include the following: electrical connection (electronic devices) having one or more wires, portable computer disk (magnetic device), random-access memory (RAM), read-only memory (ROM), erasable editable read-only memory (EPROM or flash memory), fiber optic device, and portable compact disk read-only memory (CDROM). In addition, the computer readable medium may even be a paper or other suitable medium on which the program can be printed, as for example, the paper or other medium may be optically scanned, followed by editing, interpretation, or, if appropriate, other suitable method for processing to electronically obtain the program and store it in computer memory.

It should be understood that each portion of the disclosure may be implemented in hardware, software, firmware or a combination thereof. In the foregoing-described embodiments, multiple steps or methods may be implemented in software or firmware stored in a memory and executed by a suitable instruction execution system. For example, if implemented in hardware, as in another embodiment, it can be implemented with any one or a combination of the following techniques well known in the art: discrete logic circuit with logic gates for implementing logic functions on data signals, application-specific integrated circuit with suitable combinational logic gates, programmable gate arrays (PGAs), field programmable gate arrays (FPGAs), etc.

Those skilled in the art can understand that all or part of the steps carried in implementing the foregoing implementation method can be completed by a program to instruct related hardware, and the program can be stored in a computer readable storage medium. The program, when executed, includes one or a combination of the steps of the method embodiments.

In addition, each functional unit in each embodiment of the present disclosure may be integrated into one processing module, or each unit may exist physically separately, or two or more units may be integrated into one module. The above integrated modules can be implemented in the form of hardware or in the form of software functional modules. The integrated modules, if implemented in the form of software functional modules and sold or used as stand-alone products, may also be stored in a computer readable storage medium.

The storage medium mentioned above may be a read-only memory, a magnetic disk or an optical disk, etc. Although the embodiments of the present disclosure have been shown and described, it is understood that the above-described embodiments are illustrative and are not to be construed as limiting the scope of the disclosure. Variations, modifications, substitutions and transformations of the above-described embodiments may be made by those skilled in the art within the scope of the disclosure.

What is claimed is:

1. A data conversion method applied to a data conversion device, comprising:
receiving a camera control signal transmitted by a remote control device;
converting a format of the camera control signal to a protocol format of a camera; and
transmitting the converted camera control signal to the camera;
wherein the data conversion device is configured to be connected to a gimbal and the camera, and the gimbal is configured to be controlled by the remote control device.

2. The method according to claim 1, wherein the camera control signals comprises at least one of: an action execution signal or a parameter setting signal.

3. The method according to claim 2, wherein the action execution signal comprises one of: a photographing instruction signal configured to instruct the camera to perform a photographing function or a focus signal configured to instruct the camera to perform a focusing function.

4. The method according to claim 2, wherein camera parameters corresponding to the parameter setting signal comprises at least one of: a shutter control parameter, an aperture parameter, an exposure parameter, an exposure mode, a white balance parameter, a white balance mode, or an infinity and auto focus mode switching.

5. The method according to claim 1, further comprising:
receiving data information transmitted by the camera;
converting a format of the data information into a protocol format of the gimbal or a UAV that carries the gimbal; and
transmitting the converted data information to the gimbal or the UAV.

6. The method according to claim 5, wherein transmitting the converted data information to the UAV comprises:
transmitting the converted data information by the gimbal to the UAV.

7. The method according to claim 5, wherein the data information comprises at least one of: camera parameters or image information captured by the camera.

8. The method according to claim 5, wherein before receiving the data information transmitted by the camera, the method further comprises:
transmitting a reading command to the camera to trigger the camera to return data information corresponding to the reading command, the reading command including a type of the data information to be read.

9. The method according to claim 8, wherein before the transmitting the reading command to the camera, the method further comprises:
receiving a camera data reading signal transmitted by the remote control device,
wherein the camera data reading signal is configured to instruct the camera to return the corresponding data information.

10. The method according to claim 1, further comprising:
in response to detecting that the gimbal is disconnected from the data conversion device, controlling a status indicator of the data conversion device to be in a first state; or
in response to detecting that the camera is disconnected from the data conversion device, controlling a status indicator of the data conversion device to be in a second state.

11. The method according to claim 1, wherein the gimbal is carried on a UAV, and the remote control device is configured to control the UAV and/or the gimbal.

12. The method according to claim 11, wherein the method further comprises:
in response to detecting that the gimbal is disconnected from the UAV, controlling a status indicator of the data conversion device to be in a third state.

13. The method according to claim 11, wherein the method further comprises:
receiving location information transmitted by the gimbal or the UAV; and
transmitting a most recently received location information to the camera.

14. The method according to claim 11, wherein receiving the camera control signal transmitted by the remote control device comprises:
receiving the camera control signal transmitted by the remote control device sequentially from the UAV and the gimbal; or
receiving the camera control signal transmitted by the remote control device from the gimbal or the UAV.

15. The method according to claim 1, further comprising:
in response to a triggering condition being met, transmitting a user prompt to the remote control device.

16. The method according to claim 15, wherein:
the user prompt comprises a prompt for prohibiting photographing; and
the triggering condition includes at least one of: the number of storable images of the camera being less than or equal to a threshold, or the camera performing a focus function.

17. The method according to claim 15, wherein:
the user prompt comprises a prompt for disabling focus; and
the triggering condition includes the camera performing a photographing function.

18. The method according to claim 15, wherein:
the user prompt comprises prompt for enabling focus; and
the triggering condition includes receiving a photographing ending signal transmitted by the camera after the prompt for prohibiting focus is transmitted to the remote control device.

19. A gimbal assembly, comprising:
a gimbal, and
a data conversion device placed on the gimbal; the data conversion device comprises:
a first processor, and
a first interface and a second interface, both connected to the first processor, wherein:
the first interface is configured to be connected to the gimbal, and the gimbal is controlled by a remote control device;
the second interface is configured to be connected to a camera; and
the first processor is configured to, in response to receiving a camera control signal transmitted by the remote control device, convert a format of the camera control signal into a protocol format of the camera, and transmit the converted camera control signal to the camera via the second interface.

20. An imaging system, comprising:
a gimbal,
a camera carried on the gimbal, and
a data conversion device, the date conversion device comprises:
a first processor, and
a first interface and a second interface both connected to the first processor, wherein:
the first interface is configured to be connected to the gimbal, and the gimbal is controlled by a remote control device;
the second interface is configured to be connected to a camera; and
the first processor is configured to, in response to receiving a camera control signal transmitted by the remote control device, convert a format of the camera control signal into a protocol format of the camera, and transmit the converted camera control signal to the camera via the second interface.
